(19) United States
(12) Patent Application Publication
(10) Pub. No.: US 2026/0000094 A1
(43) Pub. Date: Jan. 1, 2026

(54) MARINE MICROALGAL PROTEIN PREPARATIONS

(71) Applicant: Qualitas Health Inc., Houston, TX (US)

(72) Inventor: Eneko GANUZA, Houston, TX (US)

(73) Assignee: Qualitas Health Inc., Houston, TX (US)

(21) Appl. No.: 18/994,418

(22) PCT Filed: Jul. 15, 2022
(86) PCT No.: PCT/US22/37344

§ 371 Date: Jan. 14, 2025

(51) Int. Cl. A23J 1/00; A23J 3/20; A23L 33/17

(52) U.S. Cl. CPC A23J 1/009; A23J 3/20; A23L 33/17

(57) ABSTRACT

A protein preparation may be obtained from dried lipid extracted marine algae. The novel hydrolysate has high solubility and digestibility, low ash content, and high protein content (measured as g amino acid/g of product), with an essential amino acid profile that makes an excellent protein supplement for human consumption. The process utilizes a hydrolyzation reaction at high solids content to minimize water footprint and ash content, while increasing its solubility and digestibility.

### BACKGROUND OF THE INVENTION

The invention is directed to protein hydrolysates for human consumption derived from marine microalgae, such as Nannochloropsis. In embodiments, the protein hydrolysates according to the invention are prepared from a lipid extracted algae (LEA) formed as a byproduct from lipid extraction of algae to make omega-3 containing oils.

Meeting the nutritional needs of a growing global population requires sustainable solutions for supplying protein rich food and supplements from previously untapped sources. One such resource is marine microalgae, which may offer significant advantages. In these non-freshwater microalgae, there is a potential for a significant food source that will not compete for traditional agricultural resources, because some marine algae can be grown on nonarable land using brackish or salt water sources.

Protein hydrolysates are used in food as additives or as supplemented proteins. Most efforts to derive food products or protein hydrolysates from algae focus on freshwater algae. L Soto-Sierra et al., Algal Research 55 (2021) describe a method for hydrolyzing marine microalgal biomass, but the high salt content and the volumes of organic solvents used make for a prohibitively expensive extraction and the ash content in the finished product is too high for human consumption.

Another barrier to using microalgae as a commercial food source or supplement is the recalcitrant microalgae cell wall which impacts the digestibility and solubility of products derived from Nannochloropsis and other algae species. Teuling et al., 2018 Aquaculture, 499:269-282; Gong et al., 2017 Aquaculture Nutrition 24(1): 56-64.

### SUMMARY OF THE INVENTION

Against this background, the inventor herein has discovered a protein preparation from marine algae biomass having high solubility and high digestibility and which can be produced from marine algae biomass using a hydrolysis with a relatively low water and solvent footprint. Processes for making lipids for human consumption, such as omega-3 rich oils, from marine microalgae may produce LEA as byproduct. The inventors herein have discovered techniques for utilization of the LEA byproduct to prepare protein hydrolysates, arriving at an amino acid profile from the raw material that is suitable for use as a human nutritional supplement, with solubility and digestibility properties that allows the protein preparation to be processed as a beverage ingredient or used in other consumer food products.

According to embodiments of the invention, a protein preparation is prepared from marine microalgae having commercially viable protein and essential amino acid profile and acceptable taste for human consumption. In embodiments, a marine microalgal protein preparation according to the invention comprises a powder having: at least 75 g hydrolyzed protein per 100 g of the powder; and marine algae residue; wherein the powder comprises ash content equal to or less than 10 g per 100 g of the powder; and wherein the powder comprises essential amino acids in an amount equal to or more than 30 g per 100 g of the powder.

In embodiments, the protein preparation is obtained from saltwater algae of class Eustigmaticieae, and in embodiments, from Nannochloropsis, which algae has a nutritionally robust amino acid profile, including a high proportion of essential and branched chain amino acids. In embodiments the protein preparation is obtained from lipid extracted algae (LEA) as the starting material.

Solutions of the powder have low isoelectric point relative to prior art protein preparations, resulting in good solubility, particularly at low pH. Good water solubility of the powder is important so that the preparation can be utilized at relatively high concentrations in food products, including beverages, smoothies, and the like. A protein preparation according to embodiments of the invention may have a water solubility index greater than 95% at a pH of 7, in embodiments greater than 96%, greater than 97%, greater than 98%, or greater than 99%. In embodiments, the protein preparation has a water solubility index greater than 95% at a pH of 3.5, in embodiments greater than 96%, greater than 97%, greater than 98%, or greater than 99%. The low isoelectric point and consequent high solubility even at low pH ensures that stable food products can be formulated even in acidic environments, such as citrus and cola beverages. In embodiments, a portion of the finished protein preparation is tested to determine and maintain a solubility index greater than 95% at a pH in a range of 3.5 to 7 prior to packaging. In other embodiments, a portion of the protein preparation finished product is tested to determine a true protein digestibility greater than 65%, according to the rat balance (fecal) method. In other embodiments, a portion of the protein preparation finished product is tested to determine a protein digestibility corrected amino acid score (PDCAAS) greater than 65%.

The hydrolyzation process according to embodiments of the invention may provide a protein that does not gelate. This property, which results from hydrolyzation process itself, ensures stability of the product in a greater variety of food applications. In embodiments, a portion of the protein product may be tested for gelation properties prior to packaging.

In embodiments, particles of the powder may be encapsulated with a lipid and fiber containing formulation to improve taste. In still other embodiments, the hydrolyzed protein is processed and used as a nutritional supplement without first drying to make a powder.

In embodiments, the protein preparation according to the invention achieves protein content equal to or greater than 85 g per 100 g powder and ash content equal to or less than 5 g per 100 g of the powder, which is far more effective as a nutritional supplement for human consumption, in terms of both nutritional value and taste, than was achievable with any marine algae-based protein hydrolysate in the prior art.

In another aspect, the invention is a method of making a marine algal protein hydrolysate, comprising: dry milling a quantity of lipid extracted algae (LEA) to an average particle size less than 5 mm; suspending the dry-milled LEA in water to form a slurry and increasing the pH of the slurry; reacting the slurry with endopeptidase enzyme to form hydrolyzed slurry; separating a dense particulate portion of the hydrolyzed slurry by filtration to obtain a permeate; acidifying the permeate; performing nanofiltration of the acidified permeate to obtain retentate; and stabilizing the retentate by at least one of pasteurization, evaporation and drying. The finished protein preparation resulting from the method may be in powder form.

In embodiments, lipid is extracted from partially dehydrated algae to obtain the LEA for the dry-milling step and the lipid that is extracted may be used to obtain omega-3 fatty acids. This combination of techniques enables a productive use of LEA which is otherwise a byproduct. The use of a byproduct offers economic and environmental advantages compared to a single product. The process provides for an economical manufacture of a protein preparation which has high protein content, is stable for food processing, and is suitable for human consumption.

In embodiments, the slurry is reacted with endopeptidase at greater than 20% solids to reduce foaming. For example, the step of reacting the slurry may comprise reacting the slurry with serine endopeptidase at a slurry solids content of at least about 30% further control foaming. In embodiments, the endopeptidase is a mild reactant, such as Formea Sol® endopeptidase.

The method may comprise containing the powder in consumer packaging for use as a nutritional supplement consisting essentially of the powder. Thus, the protein preparation in powder form may itself constitute a food product for human consumption. In other embodiments, the protein preparation may be suspended or dissolved in an aqueous suspension or solution for human consumption. For example, the product may be embodied as a beverage, having stability even in acidic environments such as citrus drinks and colas, because of its excellent solubility.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a process flow diagram for producing a protein hydrolysate according to an embodiment of the invention

It will be appreciated that for simplicity and clarity of illustration, elements shown in the FIGURES have not necessarily been drawn to scale and some elements not necessary for an understanding of the invention have been omitted. For example, the dimensions of some of the elements may be exaggerated relative to other elements for clarity. Further, where considered appropriate, reference numerals may be repeated among the FIGURES to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

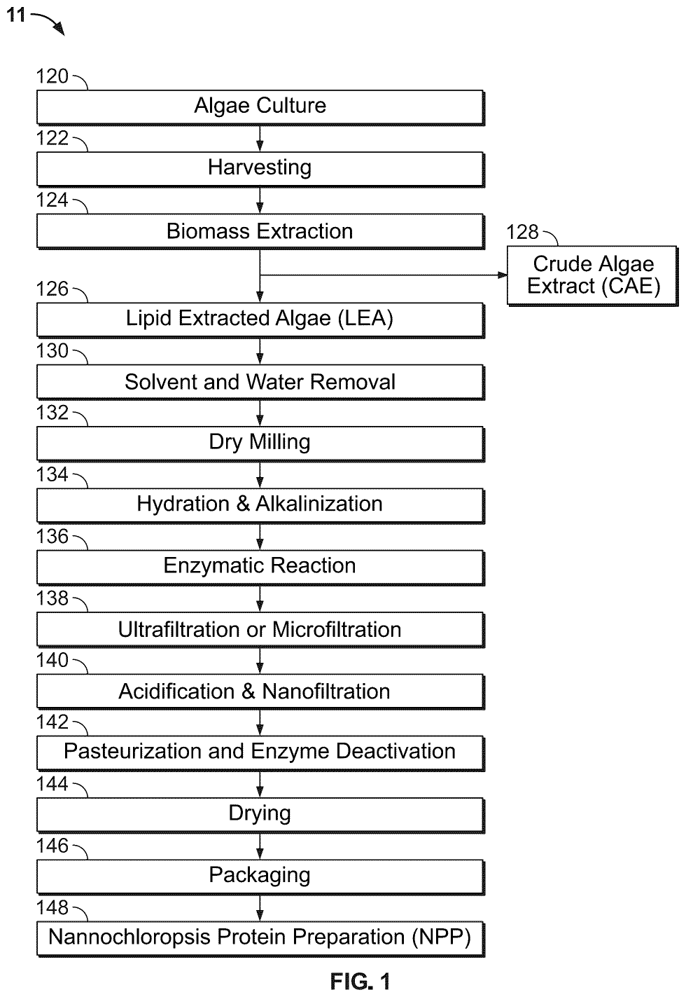

A significant starting material for the protein preparation according to the invention is lipid extracted algae (LEA). Referring to FIG. 1, LEA 126 may be obtained following algae culture 120, harvesting 122 and biomass extraction 124 to form crude algae extract (CAE) 128. In embodiments, the CAE and LEA may be derived from marine microalgae, which is defined as microalgae that is cultured with at least 5-60 g salt/L. The commercial supplement Omega-3 (compositions high in Omega-3 compounds) may be extracted from the microalgae, including Nannochloropsis, used in the examples below. The LEA may be a byproduct of this commercial Omega 3 operation. The inventors herein have found that drying and solvent removal from the byproduct starting material, or at least partially drying it, permits performing hydrolyzation at significantly higher solids content, up to 35% solids or more, which ensures a modest water footprint for the entire process, which in turn is critical for economic viability. Thus, in embodiments LEA starting material may be dried to a water content in a range up to about 10% (w/w), and in embodiments below 5%.

Whereas conventional teaching suggests wet milling the starting material to a fine particle size in suspension to access the cellular material, the inventors have found that a step of hammer milling 132 the dried material to a particle size in a range of 0.1 mm to about 0.5 mm yields excellent results, and in embodiments a particle size in a range of about 0.1 mm to about 0.25 mm is obtained.

In step 134, the pulverized LEA is mixed with filtered water to form a slurry and the pH of the slurry is raised, for example adding ammonium hydroxide, to conduct a hydrolyzation reaction with enzyme. The pH may lower spontaneously during the course of the reaction and may be monitored throughout. The initial mixing may proceed for a period of about 5 minutes to an hour, in embodiments mixing 10 to 30 minutes, depending on the scale, ensures that the pulverized LEA remain suspended.

For the enzymatic hydrolyzation reaction itself 136, the inventor has found that a relatively mild exopeptidase enzyme decreases the bitterness of the resulting hydrolysate. For example, an exopeptidase may be used, alone or in combination with a serine endopeptidase. In the specific examples elaborated below, Formea Sol® endopeptidase and Flavorzyme® exopeptidase were used. The reaction may be conducted in a jacketed continuously stirred tank reactor and agitated throughout-in the example below the reaction lasts about 2 hours. Depending on scale, the high solids content batch (above about 30% solids) may be reacted for a period of about 1 to 6 hours.

Following the hydrolyzation reaction, the hydrolysate is returned to room temperature and acidified prior to heat treatment (pasteurization) and a subsequent microfiltration or nanofiltration step 138. For this purpose, HCl may be employed, as in the Examples below, although other reagents may be acceptable, to reach a pH of about 6-6.5 for the next step.

The hydrolyzed slurry tops may be decanted and subjected to ultrafiltration or microfiltration with a 500 kDa hollow fiber membrane having an inner diameter of at least 1.5 mm. In other embodiments ultrafiltration is replaced by microfiltration using for example a ceramic membrane with a 0.1 um pore size and inner diameter of at least 1.0 mm.

In embodiments, nanofiltration of the acidified permeate yields a retentate which may be subjected to pasteurization and enzyme deactivation 142 and drying 146 to form a protein preparation in the form of a powder with high protein content and low ash content. Acidifying the feed avoids protein leakage and permits using a nanofilter with less than 600 Dalton size, which effectively separates water, minerals and ash from the protein peptides. Acidifying the permeate affects the charge of the peptides and allows separation in the nanofiltration step, which is affected by polarity and not merely pore size. In contrast, ion exchange, practiced in the prior art, operates by electrolyte exchange, resulting in significant protein loss and unacceptable ash content.

The marine microalgae hydrolysate according to embodiments of the invention is a fine, pale-yellow powder, with a somewhat bitter and savory (“Umami”) taste, as evaluated using the Eurofins Internal Sensory Analysis protocol. The pH of a 10% w/w solution of the powder may be about 4-6.5 as determined by AOAC 981.12. Solubility was significantly improved as compared to most commercially available protein powders-above 98% as measured according to the IDF standard method 129A. In embodiments, the hydrolysate powder according to the invention has protein content by this measure of at least 75% according to AOCS 2001.11 method. Moreover, ash content can be kept below about 15%, in embodiments below about 10% and in other embodiments below about 5% without prohibitively expensive (and often ineffective) ion exchange processing. A proximal composition profile of the hydrolysate powder according to embodiments of the invention is shown in Table 1, together with the method for characterization. Each standard used herein for characterization of products is known to a person skilled in the art, and a reference to published standards refers to the standards in effect on the filing date of this application

TABLE 1

| Chemical | | U of | |
|---|---|---|---|
| Analysis | Values | M | Method |
| Protein | 75.0-85.0 | G | AOAC 2001.11; Kjeldahl |
| | | | (N × 6.25) |
| Total Amino Acid | 75.8 | G | AOAC 982.30, 988.15 & |
| | | | 994.12 mod. |
| Ash | 5-10 | G | AOAC 942.05 |
| Total Carbohydrate | 6-10 | G | CFR 21 - Calculated |
| Total Fat | <0.3 | G | AOAC 954.02 |
| Moisture | 3-10 | G | AOAC 925.09 |
| Calories | 320-370 | Kcal | CFR 21 - Atwater Calculation |

The amino acid (AA) profile of the product according to embodiments of the invention is significantly higher than in the native product, as set forth in Table 2.

TABLE 2

| | Range |
|---|---|
| | (g AA/100 g |
| AA | product) |
| Alanine | 5.1-6.3 |
| Arginine | 3.4-4.6 |
| Asparagine + | 7.6-10.7 |
| aspartic acid | |
| Cysteine | 0.4-0.6 |
| Glutamine + | 9.4-13.6 |
| glutamic acid | |
| Glycine | 4.2-5.7 |
| Histidine | 0.9-1.3 |
| Isoleucine | 2.7-4.0 |
| Leucine | 5.7-7.2 |
| Lysine | 4.3-6.0 |
| Methionine | 1.7-1.9 |
| Phenylalanine | 3.0-3.4 |
| Proline | 3.4-4.8 |
| Serine | 3.2-4.0 |
| Threonine | 3.7-5.1 |
| Tryptophan | 0.7-3.7 |
| Tyrosine | 2.1-2.7 |
| Valine | 4.1-5.8 |
| Total | 65.6-91.4 |

Essential amino acids are defined as any combination of cysteine, histidine, isoleucine, leucine, lysine, methionine, phenylalanine, threonine, tyrosine, and valine. Mild processing during the hydrolyzation reaction may provide essential amino acid content of at least 30 g per 100 g product which is a higher ratio than in the natural product. Likewise, the branched chain amino acids content (valine, leucine and isoleucine) may be obtained greater than 13 g per 100 g product.

Ranges for essential amino acid composition in a Nannochloropsis Protein preparation (NPP) according to the invention are set forth in Table 3.

In general, protein solubility decreases with decreasing pH close to the isoelectric point. For food preparations high solubility at acidic pH (as low as about 3.5) as well as in neutral pH (pH about 7) is desirable, and in embodiments, a protein preparation according to the invention has solubility of greater than 95% at a pH in a range of 3.5 to 7. A solubility index was measured at pH 3.4 and 7 by IDF standard method 129A as set forth below and found to be above 98% and in some cases above 99%. The insoluble portion in all the sample batches was less than 1 ml and hence the amount of insoluble portion was low in comparison to other protein powders available. This also includes the observation that the protein hydrolysate is highly soluble. Additionally, the solubility was also tested by adding 8.6 g in 30 ml of which is equivalent to addition of 24 g in 3 oz of protein drinks. The insoluble portion was less than 1 ml and the solubility at room temperature was found to be 99.54%. This makes the inventive algal protein hydrolysate an excellent ingredient to be added to food products without creating solubility problems.

Maintaining a relatively low pH, for example below 6.5 may reduce the likelihood of Maillard reactions (browning) in the steps in which heating occurs, for example, pasteurization may be carried out at a pH of about 4.

According to embodiments of the invention, the composition profile of the protein preparation has been modified to enhance the potential to use the powder in certain food products. Depending on the application, key factors affecting such suitability for food processing may include protein content (also referred to as protein density), protein digestibility, solubility, foaming and gelation. In some cases, these process objectives may be complementary and in other embodiments these objectives may be competitive with one another. For example, an increase in solubility may go along with an increase in digestibility; but keeping a desired protein content and especially desired essential amino acid content above a predetermined nutritional threshold, may run counter to the requirement for high solubility and digestibility.

TABLE 1
Essential amino acid composition in
Nannochloropsis Protein preparation (NPP)
Amino acid (g/100 of powder)

| | |
|---|---|
| Histidine | 1.1-3.0 |
| Isoleucine | 3.6-7.4 |
| Leucine | 6.7-10.2 |
| Lysine | 45.0-7.0 |
| Methionine | 1.7-3.0 |
| Phenylalanine | 3.0-5.5 |
| Threonine | 4.1-6.1 |
| Tryptophan | 1.0-3.1 |
| Valine | 4.0-6.1 |
| Total Essential Amino Acids | 40.6 ± 7.5 |
| Total Branched Chain Amino | 18.7 ± 4.6 |
| Acids | |

As with any food product or nutritional supplement, it may be desirable to add flavors, exogenous amino acids and/or other functional components to the protein preparation to prepare a food product or nutritional supplement. The exemplary compositions described and claimed herein were obtained directly from the extraction/hydrolyzation process of microalgae but the description is intended to include compositions having post-added amino acids or other functional ingredients.

An exemplary minerals profile of a protein preparation according to embodiments of the invention is set forth in Table 4.

TABLE 4
Minerals Profile (Average values for 100 g of product):

| Chemical Analysis | Values | U of M | Method |
|---|---|---|---|
| Potassium | 35-3750 | mg | AOAC 984.27 |
| Phosphorus | 678-2240 | mg | AOAC 984.27 |
| Calcium | 97-1970 | mg | AOAC 984.27 |
| Sodium | 5-1320 | mg | AOAC 984.27 |
| Magnesium | 266-1320 | mg | AOAC 984.27 |
| Acid Insoluble Ash | 100-630 | mg | AOCS Ba 5b-68 |
| Chloride-Soluble | 0-120 | mg | AOAC 971.27 |
| Iron | 1.5-10 | mg | AOAC 984.27 |

Hydrolyzation is effective to prevent gelation of the proteins. To assess gel strength, 8 ml of protein solutions were prepared in distilled de-ionized water at pH 7 and stirred continuously for 2 hours. 1 ml of the sample was dispersed into oiled microcentrifuge tubes using a positive displacement pipette. The microcentrifuge tubes were sealed and heated in a water bath at 95 C. Heat induced protein gels were formed. The time and the protein concentration of the samples were determined by various trails. After cooling completely to room temperature, the gels were removed from the tubes by cutting the tips off and using a gentle stream of aim to blow out the gels. The strength of the gels was measured by using a TA-XT plus texture analyzer (Stable micro systems LTD, Surrey, UK) using a 100 mm diameter probe. 5 mm/s test speed and a target distance of 0.5 mm from the plate. The maximum force measured is the force to rupture the gels.

The utility of the protein hydrolysate preparation for use in food applications is improved if it exhibits good foaming properties. To assess foaming properties, a 12% protein solution was prepared for analyzing the foaming capacity and stability. 2 ml of 12% protein solution was added into a beaker containing 50 ml of water. The protein solutions were adjusted to pH 7 and 3.4 respectively. After a constant mix, the solutions were carefully transferred onto an electric mixer. The electric mixer was operated (KitchenAid®, Greenville, OH) at speed 8 for 2 minutes. The solution was then transferred into a 250 ml graduated cylinder. The initial and final volumes of the liquid level and initial foam level were noted. After 30 min the final level of liquid+foam level were recorded. The foaming capacity and stability were calculated according to the formula as foam volume=total volume of liquid+foam−the final volume of the liquid; foaming capacity=initial foam volume (ml)/0.25 (g protein) and the foaming stability=100*(final foam volume/initial foam volume).

Emulsion stability and activity index were determined based on the turbidimetric method. 25 ml of 0.1% protein solutions was prepared and adjusted to pH 7. After 2 hours of stirring, a 5 ml of solution was added to a 50 ml beaker containing 1.67 ml of corn oil and immediately homogenized at 10,000 rpm. After 1 minute of homogenization, 50 μl of the emulsion was added to 5 ml of 0.1% SDS to prevent flocculation of the samples and be vortexed for 5 sec. The samples were then transferred to a cuvette and the initial absorbance of the emulsion was read at 500 nm using UV/VIS spectrophotometer. After 10 minutes, another 50 μl of the sample was vortexed with 5 ml of 0.1% SDS and the final absorbance was measured. The ES may be determined using the equation:

$$Emulsion Stability ( min ) = A 0 / ( A 0 - A 10 ) \times 10 min$$

$$Emulsion Activity Index ( m 2 / g ) = 2 T / ( 1 - ∅ ) C$$

$$A 0 - Initial absorbance$$

$$A 10 - Final absorbance$$

$$C - Weight of the protein per volume of aqueous phase$$

$$∅ - Volume fraction of oil$$

$$I - path length$$

$$T - turbidity of oil at 500 nm = 2.303 \times A 0 / 1$$

Emulsion capacity (EC) was analyzed by diluting 1 mL of the 12% protein solution with 11 mL of pH 7 water and stirring to dissolve. 5 mL of this solution was added into a 250 ml beaker and homogenized with oil added dropwise into the beaker. The breaking point of the emulsion changed its appearance from smooth to grainy/chunky and decreased its viscosity. The homogenization was stopped and the titration of oil when the emulsion breaks was recorded as the final oil volume in the burette. The results are expressed as g oil emulsified by g of protein in the sample solution:

$$EC ( ( g oil emulsified ) / ( g of protein ) ) = oil titrated ( mL ) \times 0.868 ( g / mL ) \times 1 / 0.05 ( 1 / g )$$

EC was reported per g protein, so this result was divided by the mass of protein (i.e., 5 mL of a 1% solution=0.05 g).

### Example 1

An exemplary process for making protein hydrolysate from LEA follows FIG. 1. 100 kg of LEA was hammer-milled to a particle size less than 0.5 mm. The pulverized LEA was suspended in 185 liters of RO-filtered water to obtain a slurry of about 35% solids. The pH of the slurry was adjusted to about 9.5 using NH₄OH, KOH or NaOH at a concentration of 30% NH₃ (% w/v) allowing a moderate temperature increase to 50 C, which was maintained throughout the hydrolyzation. The slurry was mixed vigorously for 10 min to maintain the algae in suspension. Granulated Novozyme® 11026 was added at 0.1 g/g protein (calculated in the biomass) and the reaction was allowed to proceed for 2 hours at constant temperature with mixing. The pH was monitored continuously during the enzymatic reaction.

The slurry was brought back to room temperature and the pH corrected to 6 with added HCl.

Ultrafiltration of the hydrolysate began under non-pressurized conditions to acclimate the membrane to the feed. In this example, ROMICON® 6-inch hollow fiber filter having a 106 mil cartridge lumen and a 64 sq. ft (5.9 m²) membrane was used. The feed was maintained at 40° C. which may decrease viscosity and maintain a stable temperature as the filtration proceeds). The hydrolysate permeation rate remains constant for over 8 hours. The crossflow starts dropping at solids content of about 20% in the retentate. Following ultrafiltration, the retentate was discarded and the permeate subjected to nanofiltration in a nanofiltration step.

Prior to nanofiltration, the pH of the permeate was adjusted to 4 using HCl. Nanofiltration of the hydrolysate removed water and salt, yielding an ash content below 10 g per 100 g on a dry weight basis. 100 L of diafiltration DI water was added and the retentate ultimately concentrated from 4 to 30% solids using a tight 150-300 Da membrane to minimize product loss below 20%. (Synder NFX3030 31 mil feed spacer having a membrane size of 87 sq ft (8 m²)). The membrane was backflushed at the end of nanofiltration to recover protein trapped in the membrane pores.

The product pH was pasteurized (and enzyme deactivated) by incubating at 85° C. for 5 min. The product may be spray dried or freeze dried for further processing.

Solubility was measured by IDF standard method 129A. Six grams of the sample were mixed with 100 ml of distilled water at 4000 rpm for 90 min. 6-8 drops of anti-foaming agent were added to prevent the formation of foam. The samples were then transferred to 50 ml centrifuge tubes and centrifuged (Beckman GS6 series, GH 3.8 horizontal rotor, Beckman Coulter Inc., Brea, CA) at 940 rpm for 5 min. The sediment-free liquid was cleared, and distilled water added to fill up the centrifuge tubes and once again centrifuged for 10 min at 900 rpm. The amount of sediment in ml is calculated.

The insolubility index measured in this way was tested at pH 7 and 3.4. The insoluble portion in all the sample batches was less than 1 ml and hence the amount of insoluble portion was low in comparison to other protein powders available. This also includes the observation that the protein hydrolysate is highly soluble. Additionally, the solubility was also tested by adding 8.6 g in 30 ml of which is equivalent to addition of 24 g in 3 oz of protein drinks. The insoluble portion was <1 ml and the solubility at room temperature was found to be 99.54%. This makes algal protein an excellent ingredient to be added into any food products without the issue of solubility.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. (canceled)

2. The protein preparation of claim 12, wherein the powder has a water solubility index greater than 95% at a pH of 7.

3. The protein preparation according to claim 12, wherein said marine microalgae belongs to class Eustigmaticieae.

4. The protein preparation according to claim 12, wherein the protein has a water solubility index greater than 95% at a pH of 3.5.

5. The protein preparation according to claim 12, wherein a viscosity of a solution of the protein does not increase after the liquid after heat induced gelation.

6. The protein preparation according to claim 12, wherein said marine microalgae comprises Nannochloropsis.

7. The protein preparation according to claim 12, wherein the powder has an ash content less than 5 g per 100 g of the powder.

8. The protein preparation according to claim 12, wherein the powder has protein content equal to or greater than 85 g per 100 g powder and ash content equal to or less than 5 g per 100 g of the powder.

9. The protein preparation according to claim 12, comprising true protein digestibility according to the rat balance (fecal) method greater than 65%.

10. The protein preparation according to claim 12, comprising a protein digestibility corrected amino acid score (PDCAAS) greater than 65%.

11. The protein preparation according to claim 12, comprising a branched chain amino acid content equal to or greater than 15 g per 100 g product.

12. A marine microalgal protein preparation, comprising a powder having:
at least 75 g hydrolyzed protein per 100 g of the powder; and
marine algae residue;
wherein the powder comprises ash content equal to or less than 10 g per 100 g of the powder; and
wherein the powder comprises essential amino acids in an amount equal to or more than 30 g per 100 g of the powder, having the following essential amino acid profile (g/100 of powder):

| | |
|---|---|
| Histidine | 1.1-3.0 |
| Isoleucine | 3.6-7.4 |
| Leucine | 6.7-10.2 |
| Lysine | 4.0-7.0 |
| Methionine | 1.7-3.0 |
| Phenylalanine | 3.0-5.5 |
| Threonine | 4.1-6.1 |
| Tryptophan | 1.0-3.1 |
| Valine | 4.0-6.1 |

13. A marine microalgal protein preparation, comprising a powder having:
at least 75 g hydrolyzed protein per 100 g of the powder; and
marine algae residue;
wherein the powder comprises ash content equal to or less than 10 g per 100 g of the powder; and
wherein the powder comprises essential amino acids in an amount equal to or more than 30 g per 100 g of the powder,
having the following amino acid profile:

| | Range |
|---|---|
| | (gAA/100 g |
| AA | product) |
| Alanine | 5.1-8.0 |
| Arginine | 4.1-6.1 |
| Asparagine + | 9.1-13.0 |
| aspartic acid | |
| Cysteine | 0.3-1.3 |
| Glutamine + | 10.0-18.0 |
| glutamic acid | |
| Glycine | 4.5-7.5 |
| Histidine | 1.1-3.0 |
| Isoleucine | 3.6-7.4 |
| Leucine | 6.7-10.2 |
| Lysine | 4.0-8.1 |
| Methionine | 1.7-3.0 |
| Phenylalanine | 3.0-5.5 |
| Proline | 4.0-7.5 |
| Serine | 3.5-6.5 |
| Threonine | 4.1-6.1 |
| Tryptophan | 1.0-3.1 |
| Tyrosine | 2.0-4.0 |
| Valine | [[4; 0]]4.0-7.5 |

14. A marine microalgal protein preparation, comprising a powder having:
at least 75 g hydrolyzed protein per 100 g of the powder; and
marine algae residue:
wherein the powder comprises ash content equal to or less than 10 g per 100 g of the powder; and
wherein the powder comprises essential amino acids in an amount equal to or more than 30 g per 100 g of the powder, having the following essential amino acid profile (g/100 of powder):

| | |
|---|---|
| Histidine | 1.2-1.5 |
| Isoleucine | 3.8-4.7 |
| Leucine | 6.7-10.2 |
| Lysine | 6.9-7.1 |
| Methionine | 2.2-2.5 |
| Phenylalanine | 4.0-4.5 |
| Threonine | 5.1-6.0 |
| Tryptophan | 0.9-1.3 |
| Valine | 5.6-6.9 |

15. The protein preparation according to claim 14, having the following amino acid profile:

| | Range |
|---|---|
| | (gAA/100 g |
| AA | product) |
| Alanine | 6.9-7.4 |
| Arginine | 4.7-5.5 |
| Asparagine + | 10.3-12.7 |
| aspartic acid | |
| Cysteine | 0.6-0.7 |
| Glutamine + | 12.7-16.1 |
| glutamic acid | |
| Glycine | 5.7-6.7 |
| Histidine | 1.2-1.5 |
| Isoleucine | 3.8-4.7 |
| Leucine | 6.7-10.2 |
| Lysine | 6.9-7.1 |
| Methionine | 2.2-2.5 |
| Phenylalanine | 4.0-4.5 |
| Proline | 4.6-5.7 |
| Serine | 4.3-4.7 |
| Threonine | 5.1-6.0 |
| Tryptophan | 0.9-1.3 |
| Tyrosine | 2.9-3.5 |
| Valine | 5.6-6.9 |

16. A food composition comprising the powder of claim 12, in an aqueous medium, forming an edible aqueous suspension or solution.

17. A food composition comprising the powder of claim 12, and further comprising an edible encapsulation around particles of the powder.

18. A food composition comprising the powder of claim 12, and further comprising added flavors, exogenous amino acids and/or functional nutritional components.

19. The food composition according to claim 16, wherein the edible suspension or solution has a protein content equal to or greater than 5% w/v.

20. (canceled)

21. (canceled)

22. (canceled)

23. (canceled)

24. (canceled)

25. The food composition according to claim 16, wherein the edible suspension or solution at a protein content equal to or greater than 60% w/v.

26. The food composition according to claim 16, in the form of an aqueous beverage having pH less than 5.

27.-46. (canceled)
